(19) United States
(12) Patent Application Publication
(10) Pub. No.: US 2024/0140165 A1
(43) Pub. Date: May 2, 2024

(54) OPTIMAL CONTROL OF CONVECTIVE THERMAL DEVICES

(71) Applicant: GENTHERM INCORPORATED, Northville, MI (US)

(72) Inventors: Alan Chewter, Ypsilanti, MI (US); Satya Mandali, West Bloomfield, MI (US); Mobashar Ahmad, Troy, MI (US); Ankit Tiwari, Farmington Hills, MI (US); Tyler Myers, Plymouth, MI (US); Chad Westerman, Milford, MI (US)

(21) Appl. No.: 18/547,047

(22) PCT Filed: Mar. 16, 2022
(86) PCT No.: PCT/US2022/071181

§ 371 Date: Aug. 18, 2023

Related U.S. Application Data
(60) Provisional application No. 63/162,937, filed on Mar. 18, 2021.

(51) Int. Cl. B60H 1/00; B60H 1/22; B60N 2/56; F24H 3/04

(52) U.S. Cl. CPC B60H 1/00285; B60H 1/22; B60N 2/5621; B60N 2/5685; F24H 3/0405; F24H 2250/06

(57) ABSTRACT

A thermal conditioning system for a vehicle seat or other surface includes a thermoelectric Peltier device (TED) with a main side and a waste side. A flap adjusts a proportion of an airflow over the main and waste side airflow paths based on one or more operational parameters of the system. The operational parameters can include a power provided to the TED, the flow rate of the airflow, a thermal efficiency between the TED and the airflow, and/or a setpoint temperature of the airflow.

### CROSS REFERENCE

This application claims the benefit of U.S. Patent Application No. 63/162937, filed Mar. 18, 2021, the entirety of which is hereby incorporated by reference.

### BACKGROUND

### Field

This disclosure generally relates to systems and methods for control of thermoelectric climate conditioning systems.

### Related Art

Climate control systems, such as heating systems and air conditioning systems, can be used to thermally condition extensive areas, such as entire buildings, suites, or individual rooms. The cabin space of a vehicle is also typically conditioned as a unit using conventional climate control systems. However, more selective environmental conditioning can also be desirable in many contexts such as, for example, the heating or cooling of a passenger seat in a vehicle. Accordingly, various types of individualized climate control systems for vehicle seats and other environments have been used.

### SUMMARY

According to one aspect, a control method for a thermal conditionings system including a thermoelectric device (TED) includes providing power to the TED, providing an airflow across a main side of the TED with a blower at a first blower speed, calculating an operational parameter based at least on the power provided to the TED, and adjusting the airflow across the main side of the TED based on the operational parameter.

According to another aspect, the operational parameter is based on a heat transfer coefficient for a heat exchanger on the main side of the TED and a specific heat of the airflow. According to another aspect, the operational parameter is proportional to a cross-sectional area of a main side flow path of the TED. According to another aspect, the operational parameter is a mass flow rate of the airflow across the main side of the TED. According to another aspect, the mass flow rate is based on a heat transfer coefficient between the TED and the airflow. According to another aspect, the mass flow rate is based on optimizing a heat transfer rate between the TED and the airflow. According to another aspect, the heat transfer rate between the TED and the airflow is calculated based on, at least, an intake temperature of the airflow and a heat transfer coefficient of the TED. According to another aspect, the heat transfer rate between the TED and the airflow is calculated based on, at least, the power provided to the TED. The airflow is adjusted based on the operational parameter including adjusting a position of a flow control valve based on the operational parameter. The flow control valve is configured to divide the airflow between the main side and a waste side of the TED. According to another aspect, adjusting the airflow based on the operational parameter includes adjusting the first blower speed to a second blower speed. According to another aspect, the power provided to the TED is adjusted based on the operational parameter. According to another aspect, the power provided to the TED is adjusted such that a temperature of the TED matches a temperature of the airflow at an outlet of the thermal conditioning system. According to another aspect, the power provided to the TED is compared with an available power to the TED. The power provided the TED is increased to use the available power and the first blower speed is increased to a second blower speed to increase a thermal effect of the airflow. According to another aspect, the airflow, a position of the flow control valve, or the provided power to the TED is adjusted to avoid temperatures above a damaging threshold. According to another aspect, a temperature loss in the airflow between the main side of the TED and an end effector is estimated. The airflow, a position of the flow control valve, or the provided power is adjusted to avoid delivering overheated or undercooled air to the end effector. According to another aspect, the end effector is a surface of a vehicle seat, an occupant's skin, a device outlet, a footwell, or seatback. According to another aspect, the blower is not activated until the TED is capable of heating the airflow on the main side to above an acceptable temperature. According to another aspect, a humidity of the airflow is measured and a dew point of the airflow is calculated based on the measured humidity. The airflow, a flow control valve position, or the provided power is adjusted to avoid cooling the airflow below the dew point to avoid condensation within the thermal conditioning system. According to another aspect, the TED is in a heating mode and the airflow on a waste side is cooled. According to another aspect, is in a cooling mode and the airflow on the main side is cooled. According to another aspect, thermal conditioning system is disposed within a vehicle seat. According to another aspect, the airflow across a waste side of the TED is adjusted to control a delta temperature of the TED.

According to a second aspect, a control method for a thermal conditioning system including a thermoelectric device (TED) includes providing power to the TED, the TED including a main side and a waste side, providing an airflow with a blower at a first blower speed, adjusting a position of a flow control valve to divide the airflow between the main side and the waste side, the adjusted position of the flow control valve configured to achieve a setpoint temperature of the airflow. The position of the flow control valve is based on an optimal air mass flow rate across the main side of the TED to maximize a heat transfer rate from the TED to the airflow based on the provided power and the position of the flow control valve. The power to the TED achieves a temperature setpoint while maintaining the optimal air mass flow rate.

According to another aspect, the power delivered by the TED to the airflow is determined and compared with an available power from the TED. The airflow is increased by adjusting the blower to a second blower speed if there is more power available to the TED. The power to the TED is also increased. According to another aspect, the power comparison of the TED is based on a power capacity of the TED. According to another aspect, the temperatures of the TED on the main side and the waste side are estimated and the airflow, the position of the flow control valve, or the provided power is adjusted to avoid temperatures outside a specified operational range. According to another aspect, a temperature loss in the airflow between the main side of the TED and an end effector is estimated and the airflow, the position of the flow control valve, or the provided power is adjusted to avoid delivering over-heated or under-cooled air to the end effector. According to another aspect, the end effector is a surface of a vehicle seat. According to another aspect, the blower is not activated until the TED is capable of heating the airflow on the main side to above an acceptable temperature. According to another aspect, a humidity of the airflow is calculated including a dew point based on a measured humidity. The airflow, the position of the flow control valve, or the provided power is adjusted to avoid cooling the airflow below the dew point to avoid condensation within the thermal conditioning system.

According to a third aspect, a thermal conditioning system includes a thermoelectric device (TED) having a main side and a waste side. A blower is configured to provide an airflow. An adjustable flow control valve divides the airflow between a main side path across the main side of the TED and a waste side path across the waste side of the TED. At least one computer-readable memory has stored thereon executable instructions. One or more processors are in communication with the at least one computer-readable memory and configured to execute the instructions to cause the system to receive a signal indicating a power provided to the TED, receive a signal indicating a speed of the blower, receive a signal indicating a position of the flow control valve, determine an operational parameter of the thermal conditioning system based at least on the power provided to the TED and the position of the flow control valve, and send a control signal to modify the speed of the blower or the position of the flow control valve to adjust the operational parameter.

According to another aspect, the operational parameter is a mass flow rate based on a heat transfer rate from the TED to the airflow. According to another aspect, the mass flow rate is optimal for the heat transfer rate. According to another aspect, the instructions further cause the system to increase the power delivered by to the TED to achieve a temperature setpoint of the airflow. According to another aspect, the power delivered by the TED is increased to achieve the temperature setpoint optimizes the heat transfer rate. According to another aspect, the instructions further cause the system to compare the power delivered to the TED with an available power for the TED. According to another aspect, the instructions further cause the system to increase the speed of the blower and the power delivered to the TED. According to another aspect, the operational parameter is an efficiency power transferred from the TED to the airflow. According to another aspect, the operational parameter is a setpoint temperature of the airflow. According to another aspect, the instructions further cause the system to estimate a temperature of the TED on the main side and/or the waste side, and adjust the airflow, the position of the flow control valve, or the provided power to avoid temperatures above a damages threshold. According to another aspect, the instructions further cause the system to estimate a temperature loss in the airflow between the main side of the TED and an end effector, and adjust one of the airflow, the position of the flow control valve, or the provided power to avoid delivering over-heated or under-cooled air to the end effector. According to another aspect, the end effector is a surface of a vehicle seat. According to another aspect, the blower is not activated until the TED is capable of heating the airflow on the main side to above an acceptable temperature. According to another aspect, the instructions further cause the system to measure a humidity of the airflow, calculate a dew point of the airflow based on the measured humidity, and adjust the airflow, the position of the flow control valve, or the provided power to avoid cooling the airflow below the dew point to avoid condensation within the thermal conditioning system.

The foregoing summary is illustrative only and is not intended to be limiting. Other aspects, features, and advantages of the systems, devices, and methods and/or other subject matter described in this application will become apparent in the teachings set forth below. The summary is provided to introduce a selection of some of the concepts of this disclosure. The summary is not intended to identify key or essential features of any subject matter described herein

### BRIEF DESCRIPTION OF THE DRAWINGS

Various examples are depicted in the accompanying drawings for illustrative purposes, and should in no way be interpreted as limiting the scope of the examples. Various features of different disclosed examples can be combined to form additional examples, which are part of this disclosure.

FIG. 1 shows a thermal conditioning system including a blower for providing an airflow across main and waste sides of a thermoelectric device (TED) and a flow control valve for dividing the air between the main and waste sides;

FIG. 2 is an algorithm for operating the thermal conditioning system based on an operational parameter;

FIG. 3 is an algorithm for operating the thermal conditioning system based on optimizing a heat transfer rate from the TED to the airflow;

FIG. 4 is an algorithm for operating the thermal conditioning system based on multiple operational parameters.

### DETAILED DESCRIPTION

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

### Thermal Conditioning Systems

Existing gross climate control technologies can be used to provide air-conditioning and/or heating within a confined space such as a vehicle cabin. On the other hand, targeted climate control systems can be directed to specific locations to effect heating or cooling faster and/or more efficiently. Accordingly, one aspect of the present disclosure is the use of various procedures for effective and/or efficient use a thermal conditioning system.

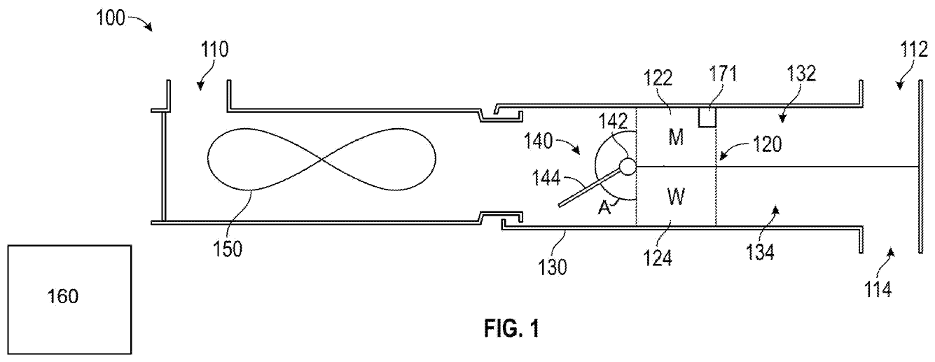

FIG. 1 shows an implementation of a thermal conditioning system 100 suitable for targeted use. The thermal conditioning system 100 can be used to deliver conditioned (e.g., heated, cooled, dried, and/or wetted) air to a climate-controlled device or environment. In an exemplary implementation, the thermal conditioning system 100 can deliver conditioned air into a vehicle seat, such as through one or more passages or channels within the vehicle seat. The thermal conditioning system 100 can also be used to provide conditioned air to various other spaces or components such as head rests, arm rests, an enclosed spaces, beds, furniture, or any touch surface that may benefit from thermal conditioning. Other implementations of thermal conditioning systems are described in WO 2020/112902, the entirety of which is hereby incorporated by reference.

The thermal conditioning system 100 can include a flow path therethrough. The flow path can extend through an outer housing 130 of the thermal conditioning system 100. The flow path can include an inlet 110 and one or more outlets 112, 114. Fluid, such as ambient air, can be drawn in through the inlet 110, conditioned using one or more conditioning elements within the system 100, and exhausted through the outlet(s) 112, 114, at least one of which provides conditioned air to the desired location.

The conditioning elements of the thermal conditioning system 100 can include a thermoelectric device (TED) 120. The TED 120 can be a Peltier device. The TED 120 can include a main-side 122 and a waste side 124. The flow path can include a main side flow path 132 that extends across the main side 122 of the TED 120 to the main outlet 112. The flow path can include a waste side flow path 134 that extends across the waste side 124 of the TED 120 to the waste outlet 114. The main-side flow path 132 can terminate at the climate-controlled environment or passageway thereto. The waste-side flow path 134 can terminate at an exhaust. The main and waste sides 122, 124 can each include a heat exchanger, such as one or more fins to enhance heat transfer between the TED 120 and the airflow passing along the respective main and/or waste side flow paths 132, 134.

The TED 120 can be connected with an voltage or amperage source such that the TED heats one side and cools the opposite side. Modification of the applied voltage or amperage can cause cooling of the main side 122 and heating of the waste side 124, or operated in the reverse polarity to cool the waste side 124 and heat the main side 122. When used as a cooling device, the main-side 122 can be colder than the waste side 124. When used as a heating device, the main-side 122 can be hotter than the waste side 124. The amount of power provided to the TED 120 can be adjusted using a duty cycle through pulse-width modulation (PWM). The TED 120 may include a temperature sensor 171, such as an NTC. The heat sensor may be located on the main side 122, such as on one of the fins.

The thermal conditioning system 100 can include or be used in combination with a blower 150, or other fluid moving device. The blower 150 can include a motor for driving one or more blades. A speed of the blower 150 can controlled based on application of a voltage and/or amperage to the motor. The blower 150 can deliver the airflow (e.g., ambient air or another fluid) along the flow path through the thermal conditioning system 100. The blower 150 can draw air in from the inlet 110 and move the air along the flow path past the TED 120 to outlets 112, 114. In the illustrated system 100, the blower 150 can be positioned, in general, upstream of the conditioning elements of the thermal conditioning system 100. However, in other implementations, a blower 150 can be positioned downstream of the conditioning elements in addition to or in the alternative to an upstream blower.

The thermal conditioning system 100 can include a flow control valve 140. The flow control valve 140 can divide and/or portion the airflow provided by the blower 150 between the main and waste-side flow paths 132, 134. The flow control valve 140 can be upstream of the TED 120. The flow control valve 140 can include a louver or flap 144. The flap 144 can be connected with a movable pivot 142. A position of the flap 144 and pivot 142 can be controlled by a motor (e.g., a servo, step, or other motor type) or other actuator. The flap 144 can be pivotable about the pivot 142 through an angle A. The angle A can vary to fully or partially close each of the main side flow path 132 and the waste side flow path 134. The effect of the position of the flap 144 on the temperature of the conditioned air at the outlet 112 is further described in WO 2020/112902.

In the illustrated implementation, the flow control valve 140 is in the form of a flap valve, however other types of valves could be used such as needle, barrel or rotary valves and/or a combination of such valves. Moreover, it is anticipated that in other implementations the flow control valve 140 can be positioned downstream of the TED 120 and/or that additional valves can be provided. For example, individual valves could be provided each of the main and waste side flow paths 132, 134.

The system 100 can further include or be connected with a controller 160. The controller 160 may include a singular unit or distributed across several devices. The controller 160 can include a processor and a non-transitory computer-readable storage medium (e.g., memory) such as a persistent magnetic storage drive, solid state drive, etc., configured to store instructions that are executable by the processor to operate the system 100 according to one or more control methods, as discussed further below. The execution of those instructions, whether the execution occurs in the processor or elsewhere, may control the entire system or sub-system(s) thereof. For example, when executed by a processor of the computer system, the instructions may cause the components of the system to operate. Operation of the system 100 by the controller 160 can be based adjusting operation of one or more of the components thereof using one or more control signals.

### Control Strategies for Thermal Conditioning Systems

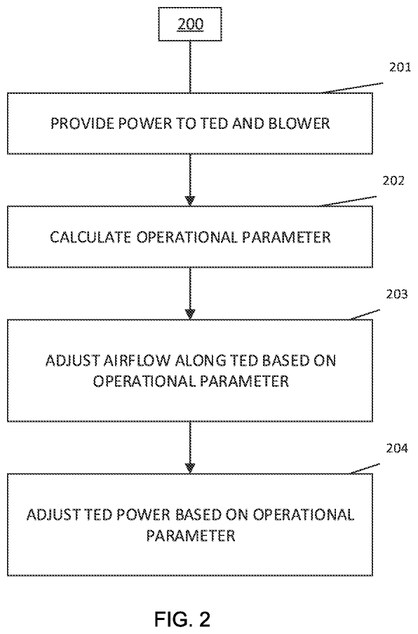

The control algorithms shown in FIGS. 2-4 and described below for use with the system 100 can be generally applied to any convective thermal heating and cooling device including for use in vehicle seat cushions, seat backs, overhead or surrounding outlets, in-dash outlets, underseat outlets, armrests, headrests, neck warmers, or other contexts. Moreover, the control algorithms can be used with Peltier or other convective thermal engine systems.

FIG. 2 illustrates a control algorithm 200 for the system 100 based on an operational parameter. Operational parameters can include: providing the conditioned air at a desired temperatures, mass flow rates, or energy consumption rates; optimizing thermal efficiency of the TED 120 and/or blower 150; operating the TED 120 within an acceptable temperature range; controlling humidity within the system 100; limiting temperatures of the end effector within an acceptable temperature range; compensating for temperature losses in the airflow; whether the system 100 is in a startup, steady-state, operating the TED 120 based on an efficiency of heat transfer to the airflow; heat transfer coefficient of a heat exchanger; specific heat of the airflow or other operating mode, etc.

At Step 201, power can be provided to the TED 120 and to the blower 150. The amount of power provided can be based on a default setting. The speed of the blower 150 can be set based on reducing noise. The TED 120 power can be set based on reaching an initial heating or cooling temperature, which may be above or below a set temperature.

At Step 202, an operational parameter of the system 100 can be calculated, such as the operational parameters listed above.

At Steps 203 and 204, the control algorithm 200 can vary one or more parameters of the system 100 to achieve the operational goals. A primary control mechanism of the system 100 can be to adjust the power supplied to the TED 120 (e.g. by controlling the duty cycle that regulates the electrical power supplied to the TED). The power provided to the TED 120 may have the largest impact on total electrical power consumption of the system 100. A secondary control mechanism of the system 100 is adjusting the position of the flow control valve 140. The position of the flow control valve 140 controls the portion of the total air flow that passes the main side of the TED 120 and can adjust the temperature and amount of the airflow passing to the outlet 112 and/or outlet 114. A tertiary control mechanism of the system 100 is to regulate the speed of the blower 150. The blower 150 can control the total air flow rate through the system 100 and accordingly the temperature and amount of the airflow passing therethrough to the outlet 112.

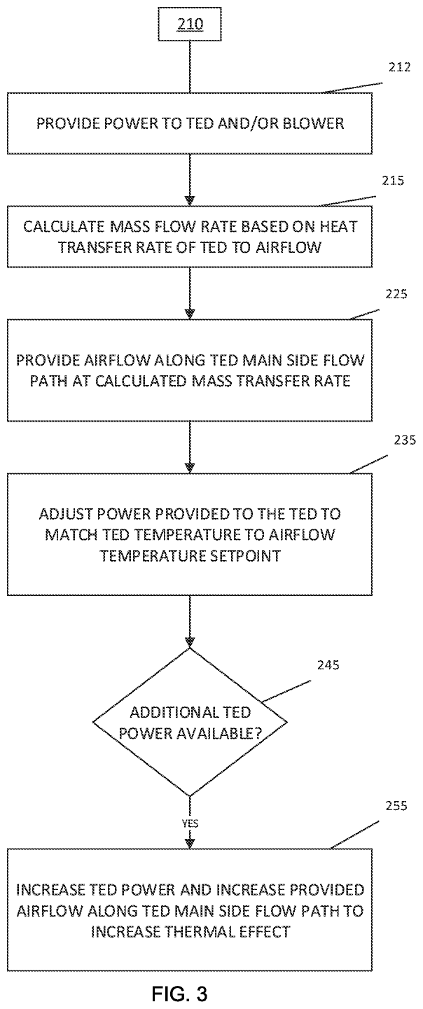

FIG. 3 shows a control algorithm 210 for the system 100 that achieves a desired outlet temperature for the airflow and increases or optimizes a thermal efficiency between the TED 120 and the airflow. In certain implementations, the control algorithm 210 regulates the airflow rate the system 100 to maximize the thermal power output when provide heating or cooling. The control algorithm 210 can maintain the highest effectual delta temperature (AT) across the TED 120 whether the system 100 is heating or cooling.

At Step 212, the system 100 can provide power to the TED 120 and/or the blower 150. The controller 160 can send a signal to provide power to the blower 150 and/or the TED 120. The initial blower 150 speed be selected based on reducing noise. The initial TED 120 setting can be 100% power or a lesser, average power consumption setting to warm or cool the initial airflow.

At Step 215, the system 100 can calculate a mass flow rate for airflow on the main side flow path 132 along the TED 120. The calculated mass flow rate (\dot{m}ₘₐᵢₙ) can be configured to optimize heat transfer between the TED 120 and the airflow on the main side flow path 132 based on the properties of the system 100 according to the relationship in Equation 1:

$$\\ \begin{matrix}{\dot{m}}_{main} = \frac{{h}_{x} {A}_{duct}}{2 {C}_{P}} & 1.\end{matrix}$$

where:
\dot{m}ₘₐᵢₙ=mass flow rate on main side flow path 132
C_{P}=specific heat of fluid in airflow
hₓ=heat transfer coefficient of TED 120
A_{duct}=cross sectional area of main side flow path 132

Equation 1 is derived based on substituting Equations 3 and 4 into Equation 2.

\dot{m}ₘₐᵢₙC_{P}(T_{ntc,fb}−T_{cabin})=hₓA_{duct}(T_{ntc,fb}−T_{film}) 2

T_{film}=(T_{ntc,fb}−T_{cabin})/2 3

T_{exit air}=T_{ntc,fb} 4

where:
T_{ntc,fb}=measured temperature of TED at sensor 171
T_{cabin}=vehicle cabin temperature
T_{film}=film temperature of airflow within main side flow path 132

Equation 2 describes the relationship between heat capacity, flow rate, and temperature and heat transfer rate for the airflow. The left side of the Equation 2 is the power carried in the airflow and the right side of Equation 2 is the power transferred from the TED 120 to the airflow. Equation 3 describes the temperature gradient in the airflow flowing through the heat exchanger of the TED 120 on the main side flow path 132. Equation 4 defines the conditions when the heat transfer rate is maximized between the airflow and the TED 120. Substituting Equations 3 and 4 into Equation 2 produces Equation 1.

The heat transfer coefficient of TED 120 (hₓ) can vary based on the temperatures or speeds of the airflow and the temperature and design of the TED 120 (e.g., heat exchangers). Accordingly, the heat transfer coefficient may be estimated based on calculations or retrieved from a reference library corresponding to the physical conditions of the system 100.

At Step 225 the system 100 can adjust the airflow over the main side flow path 132 to match the calculated mass flow rate. The airflow provided by the blower 150 can be split by the flow control valve 140 between the main side path 132 and the waste side paths 134. The desired mass flow rate can be achieved based on the position of the flow control valve 140 and the speed of the blower 150. Generally, the speed of the blower 150 can be maintained and the position of the flow control valve 140 adjusted. However, the speed of the blower 150 can be adjusted and the position of the flow control valve 140 maintained, or both can be adjusted.

The system 100 can further adjusting the airflow across the waste side 124 (e.g., on the waste side flow path 134) of the TED 120. The airflow on the waste side flow path 134 can be controlled using the flow control valve 140 and/or the blower 150. The airflow on the waste side 124 can be controlled to increases or limit a delta temperature between the main and waste sides 122, 124 of the TED 120. The delta temperature can be limited by limited airflow on the waste side 124 to prevent damage to the TED 120. The delta temperature can be increased by increased airflow on the waste side 124 to enhance the effect of the TED 120 on the airflow of the main side flow path 132.

At Step 235, the system 100 can adjust the power provided the TED 120. The power to the TED 120 can be adjusted until T_{ntc} equals the set temperature for the airflow at the outlet (Tₑₓᵢₜ). By equating T_{NTC} with Tₑₓᵢₜ, the heat transfer from the TED 120 to the airflow is maximized without requiring excess energy. The temperature setpoint is an input to this system 100.

This adjustment can be based on feedback from the sensor 171. The adjustment could also use the explicit relationship shown in Equation 5 in a feedforward based control. The adjustment could also be based on a combination of feedback and feedforward controls for an improved response. Equation 5 represents the relationship between the TED power (electrical power supplied by circuit to TED 120) to the heat transfer rate to the airstream passing the main side flow path 132.

q_{TED}=K_{calibration}\dot{m}ₘₐᵢₙC_{P}(T_{ntc,fb}−T_{cabin}) 5

where:
K_{calibration}=represents heat transfer mechanism efficiency

At Step 245, the system 100 determines the amount of power delivered by the TED 120 to the airflow (e.g., using Equation 2) and compares it with the available power (i.e., electrical power capacity) for the TED 120. The availability of excess power to the TED 120 when operating at the optimal heat transfer rate means that the system 100 may be operated for greater thermal effect by increasing power to the TED 120 and increasing the speed of the blower 150. This mode allows the device to provide maximum effect, but is not necessarily utilizing optimal heat transfer rate if the mass transfer rate calculated above in Equation 1 is exceeded.

At Step 255, the power to the TED 120 is increased and the speed of the blower 150 is increased to provide an increased thermal effect for the system 100. In certain implementations, the increased thermal effect for the system 100 can be maximized based on using 100% of the available TED power. The increased thermal effect mode may be used for various situations other than optimizing the heat transfer rate. Certain examples include preconditioning a touch surface for increased occupant comfort, drying within the system 100 or the end effector, or providing comfort otherwise unrelated to thermal effect, etc.

In certain implementations, the airflow can be increased incrementally and the TED power can be maintained as in Step 235. The airflow can be increased until the TED power saturates (e.g., main side airflow temperature drops below setpoint temperature). However, this approach may be slow and/or unstable. Alternatively, a feedforward algorithm can be used to predict the airflow level. The feedforward term can be formed in different ways. One method would be to extrapolate the current states of the system 100 to the desired state by measuring the gradients and applying a linear relationship. In one example, mass flow rate is x, going to y and power is a going to b (max power). Assuming temperature is constant, you can do a straight line interpolation and solve for the unknown mass flow rate y. A more complex solution would be to use the Equations 2 or 5 listed above as a dynamic transfer function. In this case the transfer function can solve for mass flow rate based on the known variables in the system 100. In another alternative, the incremental approach and the feedforward approach can be used together. Using either the interpolation or dynamic transfer functions feedforward approach, a mass flow rate can be calculated and the mass flow rate of the system 100 can be incrementally increased towards that calculated mass flow rate. Iterating the feedforward calculation can improve the calculated mass flow rate.

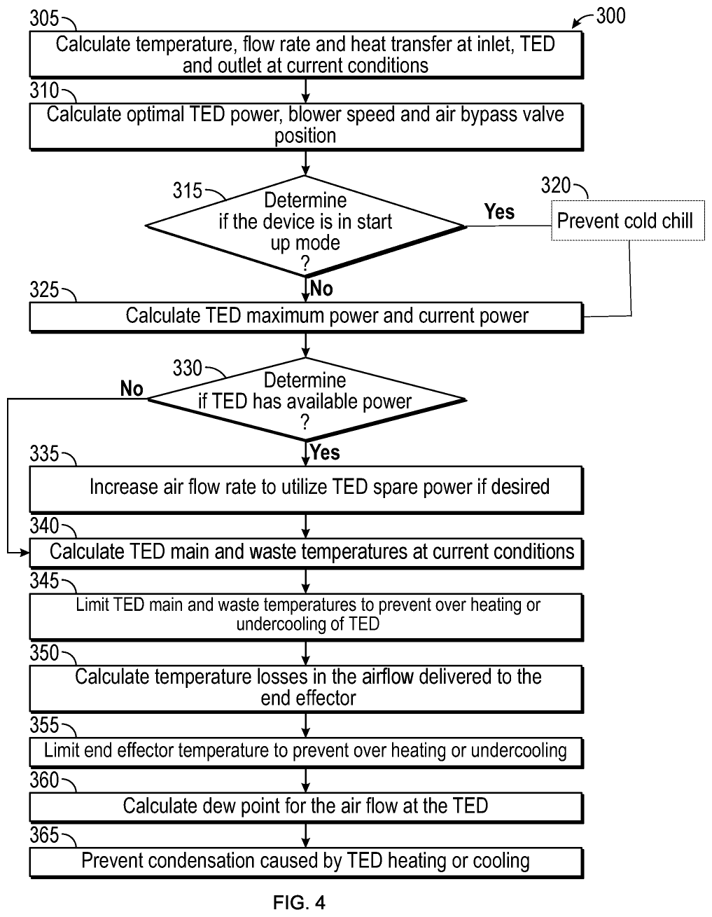

Another control algorithm 300 for operating the system 100 based on one or more operation parameters is shown in greater detail in FIG. 4. At Step 305, the system 100 can calculate, receive, and/or measure current operating conditions. These may include the temperature of the TED 120 (e.g., sensor 171), the speed of the blower 150, the position of the flow control valve 140, and/or the temperature of the airflow at the inlet (intake temperature) 110, outlet 112 and/or outlet 114.

At Step 310, the system 100 can calculate the optimal mass flow rate on the main side flow path 132, adjust the speed of the blower 150 and/or the flow control valve 140, and optimize the power to the TED 120 to achieve the thermal transfer rate as described above in algorithm 210.

At Step 315, the system 100 can detect whether it is in an initialization or startup mode. Under startup conditions, the TED 120 may not be fully up to temperature to provide sufficient heating or cooling. Providing excess airflow across an under-warmed TED may result in blowing colder air through outlet 112 than is desirable. This may result in chilling of the conditioned spaces when the system 100 is being used as a heater. Accordingly, at Step 320, the startup mode can limit blower speed or delay starting the blower 150 until the TED 120 has heated to a sufficient degree or for a specified waiting period. Whether the TED 120 has heated sufficiently may be based on timing and/or power consumption of the TED 120.

At Steps 325-335, the system 100 may calculate, and optionally utilize an increased thermal effect mode that includes power the TED 120 and/or blower speeds above the optimal mass transfer rate, as described above in algorithm 210.

At Step 340, the system 100 can estimate temperatures of the main and waste sides 122, 124 of the TED 120. This estimate may be based, at least in part, on the power provided the TED 120, the position of the flow control valve 140, temperature sensor 171, and/or the speed of the blower 150. At Step 345, the system 100 can prevent the TED 120 from exceeding temperature limits (e.g., thresholds) on either of the main and waste sides 122, 124 that could damage the device over time. If a temperature outside an allowable range is detected, one or more of the power provided the TED 120, the position of the flow control valve 140, and/or the speed of the blower 150 can be adjusted to bring the TED 120 back into the desired temperature range.

At Step 350, the system 100 estimates the temperature losses in the airflow delivered to the end effector (e.g., a seat surface) connected with the outlet 112. This calculation can be based on the airflow temperature, the ambient temperature of the cabin, the temperature sensor 171, the length of the passageway leading to the seat surface, the power to the TED 120, the position of the flow control valve 140, and/or the speed of the blower 150. At Step 355, the system 100 can prevent overheated or undercooled-air being delivered to the end effector. If a temperature outside an allowable range is detected, one or more of the power provided the TED 120, the position of the flow control valve 140, and/or the speed of the blower 150 can be adjusted to bring the airflow to the end effector back into the desired temperature range. The end effector can optionally be a vehicle seat, an occupant's skin, a device outlet, a footwell, a seatback, or other surface.

At Step 360, the system 100 calculates a dew point on a cooled side of the TED 120 (e.g., the main side flow path 132 or the waste side flow path 134, depending on heater or cooler usage). Excess cooling of humid air can result in undesirable condensation within the system 100 and/or at the end effector. The humidity of the air entering the system 100 can be known based on a signal from an outside system (e.g., vehicle). The system 100 then calculates the corresponding dew point temperature. At Step 365, if temperatures within the system 100 are calculated to cause condensation, one or more of the power provided the TED 120, the position of the flow control valve 140, and/or the speed of the blower 150 can be adjusted to prevent airflow and/or dry the flow path of the airflow. This mechanism can be applied in either heating or cooling modes of operation.

The software for the system 100 and the control algorithms above have been architected to support operation either as a standalone device that can receive temperature and flow intensity setpoints directly from the system user or as part of an integrated vehicle comfort solution where it provides information about the thermal effect of the device that can be used by the vehicle comfort control system to optimize comfort, time to comfort, and energy used to achieve both. The software and architecture have been designed to include models of the local thermal conditions in the vehicle. These calculated thermal states allow the system 100 to be used intelligently and efficiently as part of a vehicle thermal climate pre-conditioning system. Specifically the system 100 will control local temperatures according to cabin conditions and so does not need any special programming to be used in pre-conditioning mode of operation, because it will maintain the correct outlet air flow and temperature regardless of vehicle occupancy or operation. The benefit is the reduction in energy used compared with empirical control methods where the operation and setpoints must be uniquely defined in each mode of operation of the system. Certain Terminology

Terms of orientation used herein, such as “top,” “bottom,” “proximal,” “distal,” “longitudinal,” “lateral,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

### Summary

Several illustrative examples of thermal systems and controls have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one example in this disclosure can be combined or used with (or instead of) any other portion of any of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of thermal systems and related methods have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above, but should be determined only by a fair reading of the claims.

1. A control method for a thermal conditioning system including a thermoelectric device (TED), comprising:
providing power to the TED;
providing an airflow across a main side of the TED with a blower at a first blower speed;
calculating an operational parameter based at least on the power provided to the TED; and
adjusting the airflow across the main side of the TED based on the operational parameter.

2. The control method of claim 1, wherein the operational parameter is based on a heat transfer coefficient for a heat exchanger on the main side of the TED and a specific heat of the airflow.

3. The control method of claim 2, wherein the operational parameter is proportional to a cross-sectional area of a main side flow path of the TED.

4. The control method of claim 3, wherein the operational parameter is a mass flow rate of the airflow across the main side of the TED.

5. The control method of claim 4, wherein the mass flow rate is based on a heat transfer coefficient between the TED and the airflow.

6. The control method of claim 4, wherein the mass flow rate is based on optimizing a heat transfer rate between the TED and the airflow.

7. The control method of claim 6, wherein the heat transfer rate between the TED and the airflow is calculated based on, at least, an intake temperature of the airflow and a heat transfer coefficient of the TED.

8. The control method of claim 6, wherein the heat transfer rate between the TED and the airflow is calculated based on, at least, the power provided to the TED.

9. The control method of claim 1, wherein adjusting the airflow based on the operational parameter includes adjusting a position of a flow control valve based on the operational parameter, the flow control valve configured to divide the airflow between the main side and a waste side of the TED.

10. The control method of claim 1, wherein adjusting the airflow based on the operational parameter includes adjusting the first blower speed to a second blower speed.

11. The control method of claim 1, further comprising: adjusting the power provided to the TED based on the operational parameter.

12. The control method of claim 11, wherein the power provided to the TED is adjusted such that a temperature of the TED matches a temperature of the airflow at an outlet of the thermal conditioning system.

13. The control method of claim 1, further comprising:
comparing the power provided to the TED with an available power to the TED;
increasing the power provided the TED to use the available power; and
increasing the first blower speed to a second blower speed to increase a thermal effect of the airflow.

14. The control method of claim 1, further comprising:
adjusting one of the airflow, a position of a flow control valve, and the provided power to the TED to avoid temperatures above a damaging threshold.

15. The control method of claim 1, further comprising:
estimating a temperature loss in the airflow between the main side of the TED and an end effector; and
adjusting one of the airflow, a position of a flow control valve, and the provided power to avoid delivering overheated or undercooled air to the end effector.

16. The control method of claim 15, wherein the end effector is a surface of a vehicle seat, an occupant's skin, a device outlet, a footwell, or seatback.

17. The control method of claim 15, wherein the blower is not activated until the TED is capable of heating the airflow on the main side to above an acceptable temperature.

18. The control method of claim 1, further comprising:
measuring a humidity of the airflow;
calculating a dew point of the airflow based on the measured humidity; and
adjusting one of the airflow, a flow control valve position, and the provided power to avoid cooling the airflow below the dew point to avoid condensation within the thermal conditioning system.

19. The control method of claim 18, wherein the TED is in a heating mode and the airflow on a waste side is cooled.

20. The control method of claim 18, wherein the TED is in a cooling mode and the airflow on the main side is cooled.

21. The control method of claim 1, wherein the thermal conditioning system is disposed within a vehicle seat.

22. The control method of claim 1, further comprising adjusting the airflow across a waste side of the TED to control a delta temperature of the TED.

23.-44. (canceled)
